(19) United States
(12) Patent Application Publication
(10) Pub. No.: US 2020/0159150 A1
(43) Pub. Date: May 21, 2020

(54) Image Forming Apparatus, Torque Rise Point Predicting Method, Computer Program, and Control System

(71) Applicant: Konica Minolta, Inc., Tokyo (JP)

(72) Inventors: Katsuhide SAKAI, Toyokawa-shi (JP); Yasuhiro KOIDE, Toyohashi-shi (JP); Toshiaki TANAKA, Toyokawa-shi (JP); Akihiro HAYASHI, Okazaki-shi (JP)

(73) Assignee: Konica Minolta, Inc., Tokyo (JP)

(21) Appl. No.: 16/689,155

(22) Filed: Nov. 20, 2019

(30) Foreign Application Priority Data
Nov. 21, 2018 (JP) 2018-218150

(51) Int. Cl. G03G 15/20

(52) U.S. Cl. CPC G03G 15/2039

(57) ABSTRACT

An image forming apparatus has a pad type fixing device in which a lubricant is interposed between a fixing belt for heating a sheet and a pad for holding the fixing belt, and includes: a controller that controls a heater of the fixing belt to maintain a fixing temperature to be set in accordance with printing modes, at a set temperature; an acquisitor that acquires torque of a motor for rotating the fixing belt as acquired torque for each of the set temperatures; a transition predictor that predicts transition of the torque of the motor for each of the set temperatures based on the acquired torque; and a point predictor that predicts a point at which at least two transition curves based on the predicted transition intersect each other as a torque rise point at which the torque of the motor starts rising due to a decrease in the lubricant.

The entire disclosure of Japanese patent Application No. 2018-218150, filed on Nov. 21, 2018, is incorporated herein by reference in its entirety.

### BACKGROUND

### Technological Field

The present invention relates to an image forming apparatus, a torque rise point predicting method, a computer program, and a control system.

### Description of the Related Art

Image forming apparatuses having various functions such as copy, scan, facsimile, and box are spreading. This type of image forming apparatus is sometimes referred to as a “multi function peripherals (MFP)”.

An image forming apparatus incorporates various devices such as a fixing device, a scan unit, and an imaging unit. Hereinafter, such a device is referred to as an “incorporated device”.

There is an image forming apparatus that detects the temperature of any of a plurality of incorporated devices, for example, the temperature of a fixing device, and determines operation manners of the incorporated devices on the basis of the detected temperature. JP 2004-286929 A and JP 2005-208221 A disclose a technology in which a temperature sensor is provided in a fixing device, and the operation method of the fixing device is determined on the basis of the temperature detected by the temperature sensor.

The belt fixing device described in JP 2004-286929 A includes: an endless sheet-like fixing belt that is wound around a heating roller and around a nip forming member (hereinafter referred to as a “pad”) that is fixedly disposed so as not to rotate, in a state where lubricant such as grease or oil is applied to the inner side of the belt in order to reduce friction resistance against the pad; a rotatable pressure roller that is pressed against the pad with the fixing belt sandwiched between them, with a contact portion on the heating roller with the fixing belt being formed as a fixing nip; a thermistor that detects the temperature of the heating roller; and a control unit that controls the drive speed of the pressure roller in accordance with the temperature detected by the thermistor. In this device, the control unit is formed to control such that the drive speed of the pressure roller is increased together with an increase in the temperature detected by the thermistor at wane-up.

The image forming apparatus described in JP 2005-208221 A includes a scanner motor for driving a rotating mirror for laser beam scanning. This apparatus includes a detector to detect the temperature of the environment in which the image forming apparatus main body is located. When the environment in which the image forming apparatus main body is located is below a predetermined temperature, it is controlled to change the waiting time from the activation of the scanner motor until the activation of the unit to be started up next to the activation of the scanner motor, in accordance with the detected temperature. Here, the time for starting the activation of each of parts of the image forming apparatus is determined on the basis of the output of the thermistor provided in the fixing device.

In a fixing device such as a belt fixing device described in JP 2004-286929 A (hereinafter referred to as a “pad type fixing device”), the lubricant decreases in the course of use. Using a pad type fixing device with almost no remaining lubricant (hereinafter referred to as “the state immediately before occurrence of film breakage”) would increase the friction between the fixing belt and the pad, accelerating deterioration of the pad type fixing device.

The greater the friction between the fixing belt and the pad, the greater the torque of the motor for rotationally driving the fixing belt (or pressure roller) in the pad type fixing device. On the basis of this fact, it is conceivable to determine whether the lubricant is in a state immediately before occurrence of film breakage by continuously monitoring the torque of the motor. This, however, might complicate the control of the image forming apparatus.

It is, alternatively, conceivable to predict the time when the lubricant enters the state immediately before occurrence of film breakage on the basis of the remaining amount of lubricant. However, the amount of lubricant applied can vary in each of pad type fixing devices, and moreover, the amount of decrease in lubricant might depend on the using manner of the image forming apparatus by the user, making it difficult to predict the time.

JP 2004-286929 A and JP 2005-208221 A have no descriptions regarding prediction of the time to enter the state immediately before occurrence of film breakage.

### SUMMARY

The present invention is made in view of such a problem and an object thereof is to make it possible to easily predict the time when a lubricant is almost exhausted, that is, the state immediately before occurrence of film breakage, in a pad type fixing device or the like.

To achieve the abovementioned object, according to an aspect of the present invention, there is provided an image forming apparatus having a pad type fixing device in which a lubricant is interposed between a fixing belt for heating a sheet and a pad for holding the fixing belt, and the image forming apparatus reflecting one aspect of the present invention comprises: a controller that controls a heater of the fixing belt so as to maintain a fixing temperature to be set in accordance with printing modes, at a set temperature; an acquisitor that acquires torque of a motor for rotating the fixing belt as acquired torque for each of a plurality of the set temperatures; a transition predictor that predicts transition of the torque of the motor for each of the plurality of set temperatures on the basis of the acquired torque; and a point predictor that predicts a point at which at least two transition curves based on the predicted transition intersect each other as a torque rise point at which the torque of the motor starts rising due to a decrease in the lubricant.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating an example of a schematic configuration of an image forming apparatus;

FIG. 2 is a view illustrating an example of a configuration of a fixing device;

FIGS. 3A and 3B are views schematically illustrating an example of a structure of a sliding portion and how a change of the sliding portion over time appears, in a fixing device;

FIGS. 4A and 4B are diagrams illustrating an example of how a change over time appears in the rotational torque of the fixing motor;

FIG. 5 is a diagram illustrating an example of a functional configuration of a control circuit;

FIG. 6 is a diagram illustrating an example of a transition curve for each of set temperatures;

FIG. 7 is a diagram illustrating an example of a configuration of a motor drive circuit;

FIG. 8 is a flowchart illustrating an example of a processing flow in an image forming apparatus;

FIG. 9 is a diagram illustrating another example of a transition curve for each of set temperatures;

FIG. 10 is a diagram illustrating an example in which an interval is different before and after a torque rise point; and

FIG. 11 is a view illustrating an example of a control system.

### DETAILED DESCRIPTION OF EMBODIMENTS

Hereinafter, one or more embodiments of the present invention will be described with reference to the drawings. However, the scope of the invention is not limited to the disclosed embodiments.

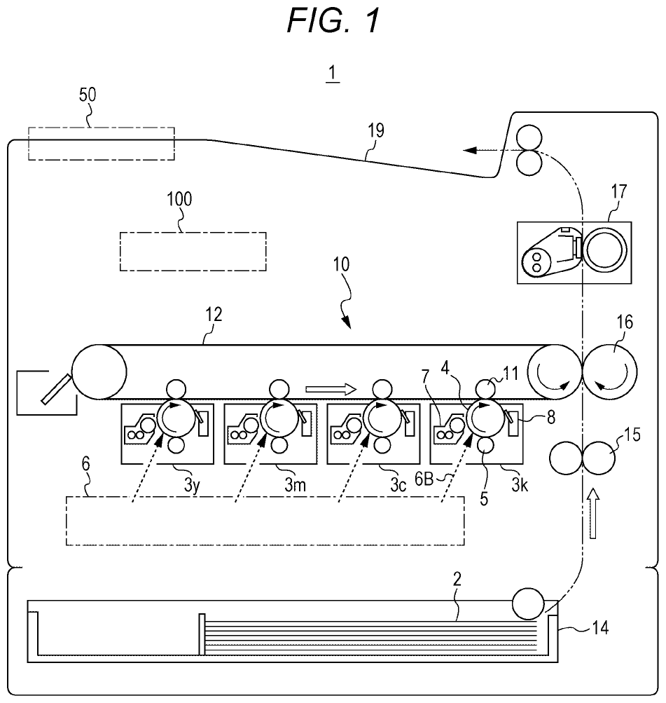

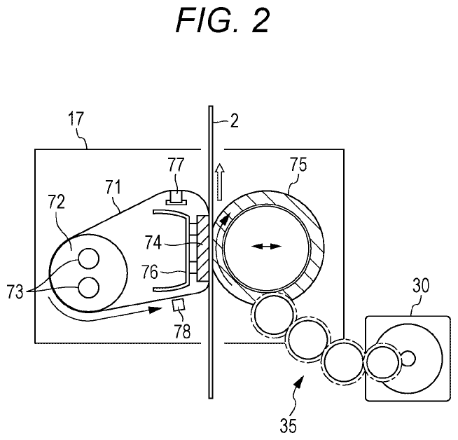

FIG. 1 illustrates an outline of a configuration of an image forming apparatus 1 according to an embodiment of the present invention. FIG. 2 illustrates a configuration of a fixing device 17 according to an embodiment of the present invention.

The image forming apparatus 1 illustrated in FIG. 1 is an electrophotographic color printer including a tandem type printer engine 10. The image forming apparatus 1 forms a color or monochrome image in accordance with a job input from an external host device via a network.

The image forming apparatus 1 includes a control circuit 100 that controls the operation of the apparatus. The control circuit 100 includes a processor that executes a control program and peripheral devices (ROM, RAM, or the like). An operation panel 50 is disposed on a front side of an upper part of a housing. The operation panel 50 includes a touch panel display that displays a screen for operation input or state display.

The printer engine 10 includes four imaging units 3y, 3m, 3c, and 3k, a print head 6, and an intermediate transfer belt 12.

Each of the imaging units 3y to 3k includes a cylindrical photoconductor 4, a charger 5, a developing device 7, a cleaner 8, or the like. The imaging units 3y to 3k have similar configurations.

The print head 6 emits a laser beam 6B for performing pattern exposure onto each of the imaging units 3y to 3k. The print head 6 performs main scanning performed by deflecting the laser beam 6B in the direction of the rotation axis of the photoconductor 4. In parallel with the main scanning, sub scanning for rotating the photoconductor 4 at a constant speed is performed.

The intermediate transfer belt 12 is a member to receive a transferred toner image in primary transfer. The intermediate transfer belt 12 is wound and rotated between a pair of rollers. Inside the intermediate transfer belt 12, there is disposed a primary transfer roller 11 for applying a transfer voltage for each of the imaging units 3y, 3m, 3c, and 3k.

In the color printing mode, the imaging units 3y to 3k form toner images of four colors of yellow (Y), magenta (M), cyan (C), and black (K) in parallel. The four color toner images are sequentially transferred to the rotating intermediate transfer belt 12 in the form of primary transfer. First, a Y toner image is transferred, and an M toner image, a C toner image, and a K toner image are sequentially transferred so as to overlap the Y toner image. In the monochrome printing mode, the imaging unit 3k alone forms a black toner image. The black toner image is transferred to the rotating intermediate transfer belt 12 in the form of primary transfer.

The toner image formed by the primary transfer is then transferred, in the form of secondary transfer, to a sheet (recording medium) 2 fed from a lower sheet feeding cassette 14 and conveyed through a timing roller 15 at the time of facing a secondary transfer roller 16. After undergoing the secondary transfer, the sheet is fed to an upper sheet discharge tray 19 through the inside of the pad type fixing device 17. When the sheet passes through the fixing device 17, the toiler image is fixed to the sheet 2 by heating and pressure.

As illustrated in FIG. 2, the fixing device 17 includes a fixing belt 71, a heating roller 72, a fixing heater 73, a pad 74, a pressure roller 75, or the like.

The fixing belt 71 is a fixing member being a flexible belt formed of a heat-resistant resin as a base material, and is rotatably provided so as to circulate around the heating roller 72 and the pad 74 while coming in contact with these components.

The heating roller 72 is heated by the fixing heater 73 incorporated in the roller, and then heats the fixing belt 71 coming in contact with the peripheral surface of the roller. The fixing heater 73 includes, for example, plurality of halogen lamps.

The fixing heater 73 performs heating to achieve a fixing temperature H, that is, for example, to achieve the temperature of the fixing belt 71 according to an embodiment of the present embodiment, specifically, the temperature 165° C. in the color printing mode, and the temperature 145° C. in the monochrome printing mode, for example.

Hereinafter, the fixing temperature H set in the color printing mode is referred to as a “set temperature H1”, and the fixing temperature H set in the monochrome printing mode is referred to as a “set temperature H2”.

The pad 74 is fixed to a stay 76 so as to face the pressure roller 75 via the fixing belt 71. The configuration of the pad 74 will be described below.

The pressure roller 75 includes a cylindrical cored bar and an elastic body that covers the periphery of the cored bar. The pressure roller 75 is supported so as to be movable in the radial direction so that the pressing force against the pad 74 can be adjusted. The pressure roller 75 is rotationally driven by a fixing motor 30. The rotational driving force of the fixing motor 30 is transmitted to the pressure roller 75 by a gear group 35.

At the time of fixing when the sheet 2 passes through the inside of the fixing device 17, the pressure roller 75 rotates while pressing the sheet 2 against the pad 74 via the fixing belt 71. At this time, the elastic body of the pressure roller 75 is deformed along the pad 74, so as to form a fixing nip having a predetermined length for pressing the sheet 2. The rotation of the pressure roller 75 conveys the sheet 2, and then, the fixing belt 71 is dragged by the sheet 2 to rotate.

At a time of standby when the fixing belt 71 is heated to a standby temperature, the pressure roller 75 is positioned in the radial direction so as to apply a minimum pressing force (light pressure) to the fixing belt 71 to rotate.

When the fixing belt 71 rotates, the fixing belt 71 slides with respect to the pad 74. In order to reduce the sliding resistance, a lubricant layer is provided between the fixing belt 71 and the pad 74. The fixing device 17 includes a lubricant reservoir 77 that supplies lubricant to the inner surface of the fixing belt 71.

In addition, the fixing device 17 includes a temperature sensor 78 that detects the temperature of the fixing belt 71. The temperature sensor 78 is disposed on the upstream side of the pad 74 in the rotation direction of the fixing belt 71. A temperature sensor 78 may be disposed inside the heating roller 72 to detect the temperature of the peripheral surface of the heating roller 72 as the temperature of the fixing belt 71.

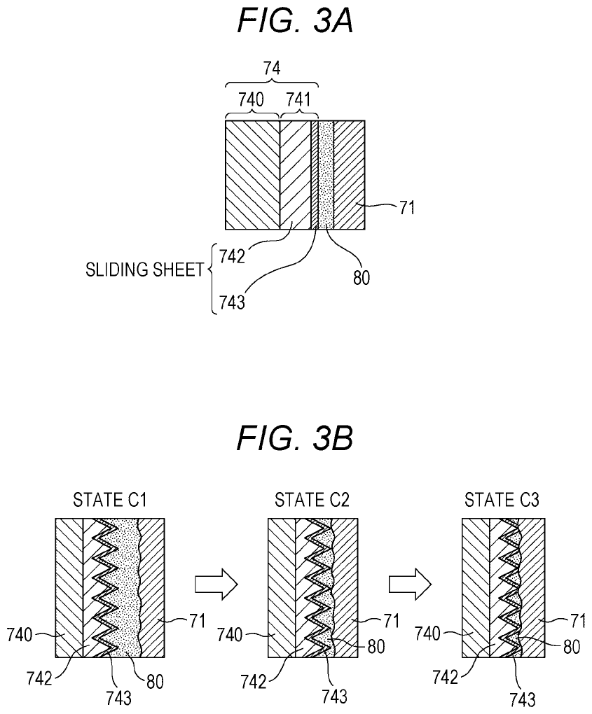

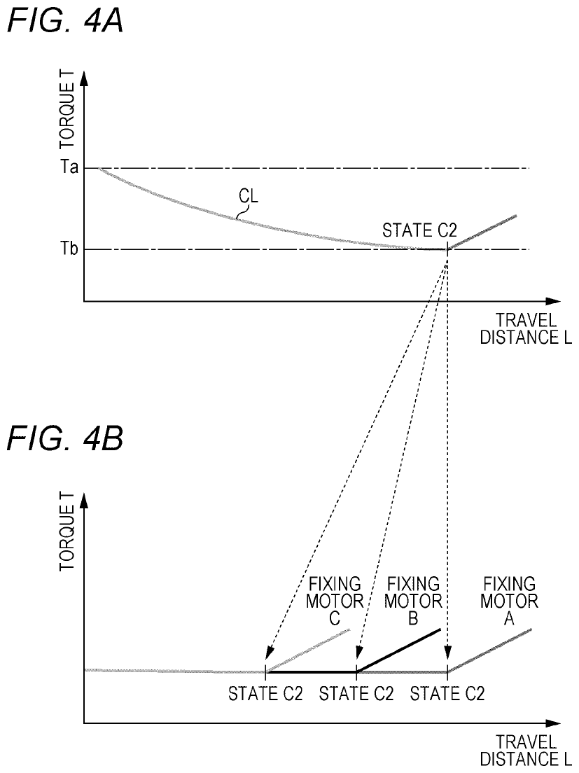

FIGS. 3A and 3B schematically illustrate the structure of a sliding portion and how a change of the sliding portion over time appears, in the fixing device 17. FIGS. 4A and 4B illustrate how the change over time appears in the rotational torque of the fixing motor 30.

As illustrated in FIG. 3A, the pad 74 includes a main body 740 and a sliding sheet 741 covering the surface of the main body 740. The main body 740 is formed by stacking an elastic body on a rigid base, for example, and has a length that is the width of the maximum size sheet 2 (length in a direction perpendicular to the drawing sheet) or more. The sliding sheet 741 includes a base material 742 and a coating layer 743 that protects the surface of the base material 742. The base material 742 is formed of a glass fiber material, for example, and the coating layer 743 is formed of a fluororesin, for example.

A lubricant 80 interposed between the pad 74 and the fixing belt 71 is supplied as synthetic lubricant grease such as silicone grease or fluorine grease. Using grease that is more viscous than oil makes it possible to suppress protrusion of the lubricant 80 from both sides of the fixing belt 71 in the width direction.

In the fixing device 17, the lubricant 80 interposed between the pad 74 and the fixing belt 71 gradually decreases. This change over time occurs by gradual protrusion of the lubricant 80 from both sides in the width direction of the fixing belt 71 along the sliding operation of the fixing belt 71.

As illustrated in FIG. 3B, the lubricant 80 is sufficiently present in the sliding portion in an initial state C1 where the image forming apparatus 1 starts to be used. In a state C2 where the change over time has progressed, the lubricant 80 has decreased to an allowable limit at which the coating layer 743 and the fixing belt 71 start to come in contact with each other. This state C2 is referred to as “a state immediately before occurrence of film breakage”. The state is sometimes described as “lubrication film breakage state”. In a state C3 where the change over time has further progressed, the lubricant 80 is almost exhausted and substantially depleted, and the coating layer 743 and the fixing belt 71 are becoming worn.

In FIGS. 4A and 4B, a travel distance L on the horizontal axis is a relative moving distance between the pad 74 and the fixing belt 71, and corresponds to the cumulative use amount concerning the change over time. The cumulative use amount may also be represented by the travel distance of the photoconductor 4, the travel distance of the pressure roller 75, the number of printed sheets (cumulative printing count) on the image forming apparatus 1, or the operating time (cumulative operating time) of the fixing device 17 or the image forming apparatus 1. Torque T on the vertical axis represents a rotational torque of the fixing motor 30 in a constant speed rotation state.

Although some difference occurs in the change over time due to individual differences and the use environment of the fixing motor 30, there is a tendency, as illustrated in FIG. 4A, that the torque T decreases until reaching a certain stage (travel distance L) and increases after the stage.

That is, the torque T gradually decreases from an initial value Ta to a value Tb as the lubricant 80 decreases. Factors underlying this gradual change over time include the reduction in the viscous resistance of the lubricant 80 due to a decrease in the amount of the lubricant 80 (that is, a decrease in the thickness of the lubricant 80). The gradual change over time continues until the state C2 is reached. After the state C2 is reached, the torque T increases steeply. Factors underlying this steep rise include the fact that the friction between the fixing belt 71 and the pad 74 is increased, so as to be load torque.

Note that, as illustrated in FIG. 4B, the stage of the steep rise in the torque T varies depending on individual differences of the fixing motor 30 (fixing device 17) in some cases.

Continuous use of the fixing motor 30 even after the state C2 would accelerate the deterioration of the fixing belt 71 due to wear, leading to the deterioration of the fixing device 17.

Meanwhile, from the viewpoint of suppressing the acceleration of deterioration of the fixing device 17, it is preferable to perform maintenance or the like on the fixing device 17 before the state C2 is reached.

Therefore, the image forming apparatus 1 includes a point prediction function for predicting a torque rise point P indicating a point at which the torque T starts to rise. The torque rise point P is used for predicting the time when the state C2 is reached, that is, the time to enter the state immediately before occurrence of film breakage. Hereinafter, the configuration and operation of the image forming apparatus 1 will be described focusing on the point prediction function.

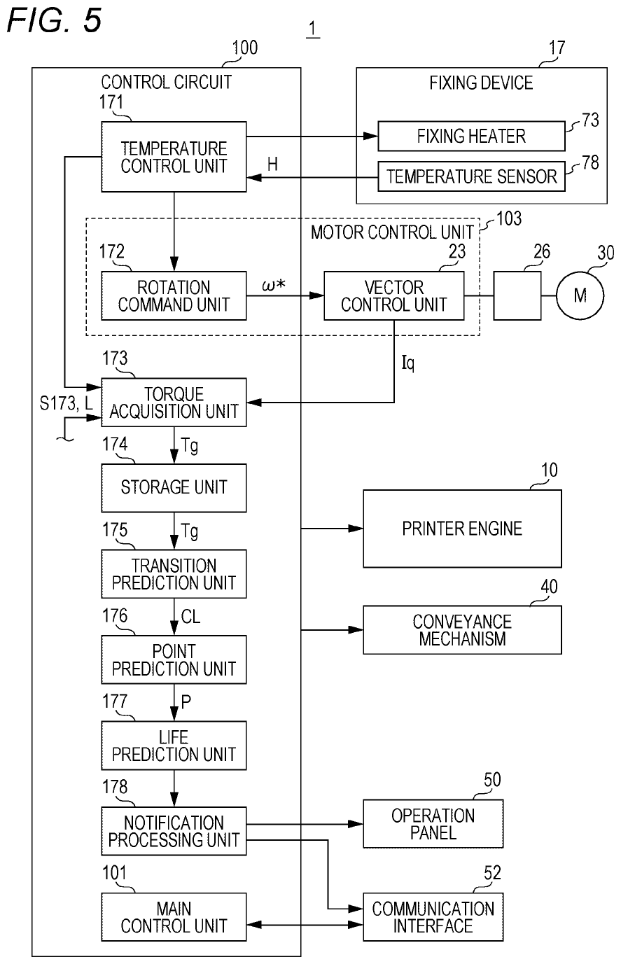

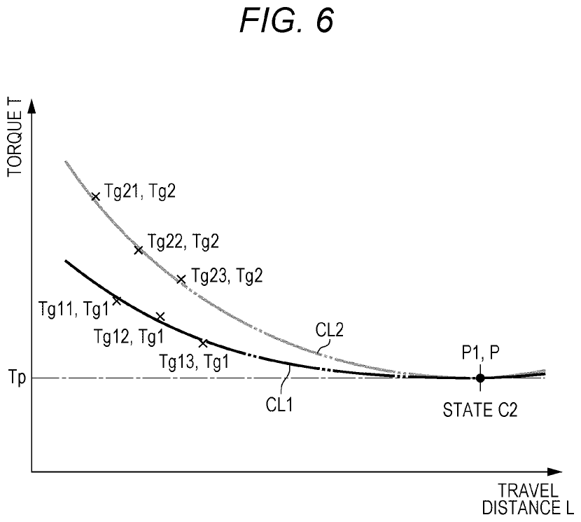

FIG. 5 illustrates a functional configuration of the control circuit 100. FIG. 6 illustrates an example of a transition curve CL for each of set temperatures.

In FIG. 5, the control circuit 100 includes a main control unit 101, a temperature control unit 171, a rotation command unit 172, a torque acquisition unit 173, a storage unit 174, a transition prediction unit 175, a point prediction unit 176, a life prediction unit 177, and a notification processing unit 178. These functions are implemented in the hardware configuration of the control circuit 100 including a central processing unit (CPU) by execution of the control program by the CPU.

The main control unit 101 is a controller responsible for overall control of the image forming apparatus 1. When a job is input from an external host device via a communication interface 52, the main control unit 101 controls the printer engine 10, a conveyance mechanism 40 or the like so as to print the number of sheets designated by the job. The conveyance mechanism 40 includes a pressure contact variable mechanism that moves the pressure roller 75 of the fixing device 17 in the radial direction.

The temperature control unit 171 controls the fixing heater 73. A target temperature Hs for fixing is set in accordance with an image forming mode (printing mode) notified from the main control unit 101, and then, the fixing heater 73 is turned on to heat the fixing belt 71. The output of the temperature sensor 78 is monitored so as to raise the temperature to the target temperature Hs. After the temperature rises to the target temperature Hs, temperature control is performed to turn on and off the fixing heater 73 so as to maintain the fixing belt 71 at the target temperature Hs.

The rotation command unit 172 gives a speed command ω* to a vector control unit 23 that controls the rotation of the fixing motor 30. The speed command ω* is a command for rotating the pressure roller 75 or the like so as to convey the sheet 2 at a fixing speed corresponding to the image forming mode.

The motor control unit 103 including the rotation command unit 172 and the vector control unit 23 rotates the fixing motor 30 at a constant speed over a start-up period Yon from the start of the temperature rise of the fixing belt 71 by the temperature control unit 171 until the temperature rises to the target temperature Hs. An example of the configuration of the vector control unit 23 will be given below.

The torque acquisition unit 173 measures the torque T of the fixing motor 30 when the fixing belt 71 rotates at a constant speed without coming into contact with the sheet 2.

The conveyance speed of the period in which the sheet 2 passes through the fixing nip, that is, the period in which the fixing belt 71 is in contact with the sheet 2 is likely to be unstable compared to the period in which no sheet 2 is passing, and there might be a change in the torque T together with a subtle change in the conveyance speed. Therefore, it is desirable to measure the torque T in the period in which no sheet 2 is passing through the fixing nip.

Examples of the period in which both the control to maintain the fixing temperature H and the control to rotate the fixing belt 71 at a constant speed are performed and in which no sheet 2 is passing through the fixing nip include a period after completion of fixing of the final sheet 2 of the print job and before stoppage of the fixing motor 30. A print job might include a period in which image stabilization processing is performed in a period from completion of passage of the preceding sheet 2 through the fixing nip and before the entry of the subsequent sheet 2 to the fixing nip, and in a case where image stabilization processing is performed in the middle of the print job.

In the present embodiment, the torque acquisition unit 173 measures the torque T by converting a q-axis current value Iq from the vector control unit 23 into the torque T. At this time, a torque constant specific to the fixing motor 30 may be used for the q-axis current value Iq.

The torque acquisition unit 173 measures the torque T periodically in accordance with a periodic measurement command S173 from the main control unit 101, for example. The periodic measurement command S173 is given to the torque acquisition unit 173 every time the travel distance L reaches a predetermined distance (that is, every time the cumulative use amount reaches a predetermined amount), for example. The predetermined distance (amount) may preferably be set at the initial stage at which the user starts using the image forming apparatus 1, for example.

The timing for measuring the torque T does not have to be exact, and may be a timing at which the travel distance L is slightly less than or slightly greater than a predetermined distance. The timing can be appropriately adjusted in accordance with the input status of the print job.

In addition, after the lubricant 80 is almost exhausted (state C2), as will be described below, it is preferable to set the interval for measuring the torque T to be shorter than the interval before entering this state. Therefore, the measurement interval is preferably varied in accordance with the stage of change of the fixing belt 71 over time.

Meanwhile, the torque acquisition unit 173 receives a periodic measurement command S173 and notification of the travel distance L at that time from the main control unit 101.

After measurement of the torque T, the torque acquisition unit 173 acquires the torque T as acquired torque Tg. Hereinafter, the acquired torque Tg acquired by the torque acquisition unit 173 at the set temperature H1 is referred to as “acquired torque Tg1”, and the acquired torque Tg acquired at the set temperature H2 is referred to as “acquired torque Tg2.” Furthermore, an interval at which the torque acquisition unit 173 measures the torque T, that is, a time interval for acquisition of the acquired torque Tg is referred to as an “interval INT”.

The storage unit 174 stores the acquired torque Tg acquired by the torque acquisition unit 173 in association with the set temperature and the travel distance L at that time. A nonvolatile memory is used for storage.

Every time the storage unit 174 stores the acquired torque Tg, that is, every time the torque acquisition unit 173 acquires the acquired torque Tg, the transition prediction unit 175 performs processing of predicting the transition of the change in the torque T for each of set temperatures as follows, for example.

The transition prediction unit 175 acquires a plurality of values of the acquired torque Tg including the latest acquired torque Tg from the storage unit 174. Subsequently, a transition curve CL, which is an approximate curve (regression curve), is generated for each of set temperatures on the basis of the plurality of values of the acquired torque Tg by using the least square method, for example. In this manner, the transition of the change in the torque T for each of set temperatures is predicted.

As illustrated in FIG. 6, for example, when the values of the acquired torque Tg1 stored in the storage unit 174 are Tg11, Tg12, and Tg13, the transition prediction unit 175 generates a transition curve CL1 as the transition curve CL of the set temperature H1. Furthermore, when values of the acquired torque Tg2 stored in the storage unit 174 are Tg21, Tg22, and Tg23, a transition curve CL2 is generated as the transition curve CL of the set temperature H2.

Note that the transition prediction unit 175 would omit this processing when the number of values of the acquired torque Tg necessary for predicting the transition of the change in the torque T is not stored in the storage unit 174. The number may preferably be set at the initial stage at which the user bas started using the image forming apparatus 1, for example.

Every time the transition prediction unit 175 predicts the transition of the change in the torque T, that is, every time the transition curve CL is generated for each of set temperatures, the point prediction unit 176 compares the torque T on each of the transition curves CL in the interval INT or at intervals shorter than the interval INT so as to obtain a point at which individual values of the torque T match. Subsequently, the obtained point is predicted as the torque rise point P.

For example, when the transition prediction unit 175 has generated the transition curve CL1 and the transition curve CL2, the point prediction unit 176 predicts a point P1 as the torque rise point P (refer to FIG. 6).

The reason for using the torque rise point P predicted as described above for predicting the time to enter the state immediately before occurrence of film breakage is as follows.

As described above, the torque T varies depending on the amount of lubricant 80 (viscous resistance). Furthermore, the torque T also varies depending on the viscosity of the lubricant 80. Here, the viscosity of the lubricant 80 varies depending on the temperature of the fixing belt 71 in contact with the lubricant 80, that is, the fixing temperature H.

In addition, as described above, after the lubricant 80 is almost exhausted (state C2), that is, after the state immediately before occurrence of film breakage is reached, the torque T varies due to the friction between the fixing belt 71 and the pad 74.

Therefore, the transition of the torque T differs for each of set temperatures until the state immediately before occurrence of film breakage is reached, whereas the transition is substantially the same regardless of the set temperature after the state immediately before occurrence of film breakage is reached.

Accordingly, a part at which changes of the transition curves CL obtained for each of set temperatures start to be substantially the same, that is, the torque rise point P, which is the point where a plurality of transition curves CL intersects each other, is going to be used to predict the time at which the state immediately before occurrence of film breakage is reached.

Note that the point prediction unit 176 newly predicts the torque rise point P, that is, corrects the torque rise point P every time the transition prediction unit 175 predicts transition of the change in the torque T as described above. Furthermore, as described above, the transition prediction unit 175 newly predicts the transition of the change in the torque T every time the acquired torque Tg is stored, that is, every time the acquired torque Tg is acquired. Therefore, the point prediction unit 176 newly predicts, that is, corrects, the torque rise point P every time the acquired torque Tg is acquired.

After the point prediction unit 176 predicts the torque rise point P, the life prediction unit 177 performs processing of predicting the life of the fixing device 17 as follows.

The life prediction unit 177 calculates, for example, the difference between the travel distance L (cumulative use amount) at the torque rise point P and the current travel distance L (cumulative use amount), that is, calculates the remaining use life, and thereby predicts the life of the fixing device 17. The life of the fixing device 17 may be predicted by further adding a predetermined value to the calculated difference.

Alternatively, the life prediction unit 177 calculates the period until the current torque T reaches torque Tp (refer to FIG. 6) at the torque rise point P on the basis of the plurality of values of the acquired torque Tg, for example, and thereby predicts the life of the fixing device 17. It is also allowable to calculate the period from the point at which the torque T reaches the torque Tp to the point at which the torque T reaches the torque obtained by adding a value for providing a predetermined margin to the torque Tp, thereby predicting the life of the fixing device 17.

In a case where the life prediction unit 177 has predicted the life of the fixing device 17, the notification processing unit 178 notifies the user by displaying the message that the life has been predicted and the predicted life on the touch panel display of the operation panel 50.

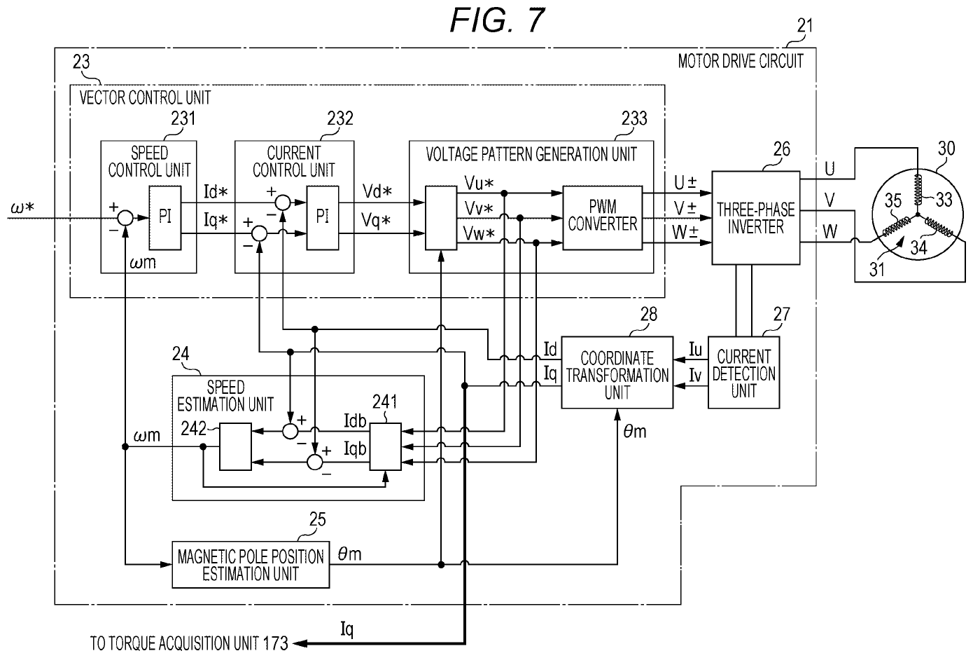

FIG. 7 illustrates an example of the configuration of the motor drive circuit 21. The fixing motor 30 can be implemented by using a DC brushless motor, for example, a sensorless permanent magnet synchronous motor (PMSM).

The fixing motor 30 includes a stator 31 as an armature that generates a rotating magnetic field, and a rotor 32 using a permanent magnet. The stator 31 has U-phase, V-phase, and W-phase cores arranged at intervals of 120 degrees, and three Y-connected windings (coils) 33, 34, and 35.

The motor drive circuit 21 performs vector control, for the fixing motor 30, to determine the direction and magnitude of the magnetic flux of the rotating magnetic field using a control model based on a d-q coordinate system. In the vector control, the three-phase alternating current flowing through the windings 33 to 35 into the direct current to flow through the two-phase windings rotating in synchronization with the permanent magnet being the rotor so as to simplify the control.

The control model defines the magnetic flux direction of the permanent magnet as d-axis, and defines the direction advanced by π/2 [rad]) (90°) in electrical angle from the d-axis, as q-axis. The d-axis and q-axis are model axes. Using the U-phase winding 33 as a reference, an advance angle θ of the d-axis represents the angular position (magnetic pole position) of the magnetic pole with respect to the U-phase winding 33. The d-q coordinate system is at a position advanced by an angle θ with respect to the U-phase winding 33.

The q-axis component flowing in the q-axis direction out of the current flowing through the windings 33 to 35 is converted into torque (rotational torque) in a direction of rotating the fixing motor 30 forward or backward in accordance with the induced voltage constant. The d-axis component (d-axis current) flowing in the direction of the d-axis is not converted into torque and is consumed as heat in the windings 33 to 35.

The motor drive circuit 21 includes a vector control unit 23, a speed estimation unit 24, a magnetic pole position estimation unit 25, a three-phase inverter 26, a current detection unit 27, and a coordinate transformation unit 28.

The three-phase inverter 26 causes the current to flow through the windings 33, 34, and 35 in accordance with control signals U+, U−, V+, V−, W+, and W− input from the vector control unit 23 so as to rotate the fixing motor 30.

The current detection unit 27 detects currents Iu and Iv that flow through the windings 33 and 34. Since Iu+Iv+Iw=0 is established, a current Iw can be obtained by calculation from the detected currents Iu and Iv. It is also allowable to provide a W-phase current detection unit.

On the basis of an estimated speed ωm input from the speed estimation unit 24 and an estimated angle θm input from the magnetic pole position estimation unit 25, the vector control unit 23 controls the three-phase inverter 26 so as to generate a rotating magnetic field that rotates at the target speed ω*. The vector control unit 23 includes a speed control unit 231, a current control unit 232, and a voltage pattern generation unit 233.

The speed control unit 231 performs calculation for proportional integral control (PI control) of bringing the difference between the above-described speed command value (target speed) ω* from the rotation command unit 172 and the estimated speed ωm from the speed estimation unit 24 close to zero, and then, determines current command values Id* and Iq* in the d-q coordinate system.

The current control unit 232 performs calculation for proportional integral control of bringing the difference between the current command values Id* and Iq* and the estimated current values Id and Iq respectively input from the coordinate transformation unit 28 close to zero, and then, determines voltage command values Vd* and Vq* in the d-q coordinate system.

On the basis of the estimated angle θm input from the magnetic pole position estimation unit 25, the voltage pattern generation unit 233 converts the voltage command values Vd* and Vq* into the U-phase, V-phase, and W-phase voltage command values Vu* and Vv*, and Vw*. Subsequently, on the basis of the voltage command values Vu*, Vv*, and Vw*, patterns of control signals U+, U−, V+, V−, W+, and W− are generated and output to the three-phase inverter 26.

The speed estimation unit 24 includes a first calculation unit 241, a second calculation unit 242, or the like, and estimates the rotation speed of the rotor 32 on the basis of the currents Iu, Iv, and Iw flowing through the windings 33 to 35 of the rotor 32.

The first calculation unit 241 calculates the current values Idb and Iqb of the d-q coordinate system on the basis of the voltage command values Vu*, Vv*, and Vw* determined by the voltage pattern generation unit 233.

The second calculation unit 242 calculates an estimated speed (speed estimated value) cam on the basis of the difference between the estimated current values Id and Iq from the coordinate transformation unit 28 and the current values Idb and Idb obtained by the first calculation unit 241 and on the basis of a voltage-current equation. The estimated speed ωm is input to the speed control unit 231 and the magnetic pole position estimation unit 25.

The magnetic pole position estimation unit 25 estimates the magnetic pole position of the rotor of the fixing motor 30 on the basis of the estimated speed ωm. That is, the estimated angle θm is calculated by integrating the estimated speed ωm.

The coordinate transformation unit 28 calculates the value of the W-phase current 1w from each of values of the U-phase current Iu and the V-phase current Iv detected by the current detection unit 27. Subsequently, on the basis of the estimated angle θm and the values of the three-phase currents Iu, Iv, and Iw, the coordinate transformation unit 28 calculates the estimated current values (d-axis current value Id and q-axis current value Iq) in the d-q coordinate system. The calculated q-axis current value Iq is used by the torque acquisition unit 173 to measure the torque T as described above.

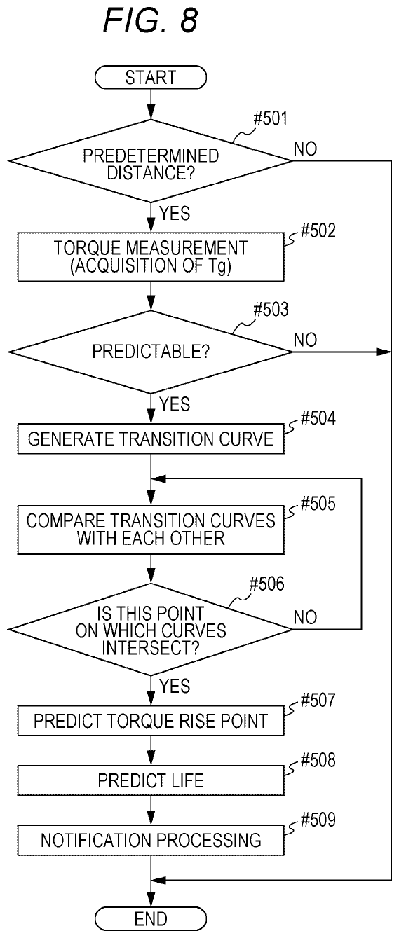

FIG. 8 illustrates a processing flow in the image forming apparatus 1. In FIG. 8, when the relative moving distance (travel distance L) between the pad 74 and the fixing belt 71 reaches a predetermined distance (YES in #501), the torque T is measured to obtain the acquired torque Tg at the set temperature (#502).

In a case where the acquired torque Tg sufficient to predict the transition of the change in the torque T has been obtained (YES in #503), a transition curve CL is generated for each of set temperatures (#504), and the transition curves CL are compared with each other (#505).

When a point where the transition curves CL intersect each other can be obtained (YES in #506), that point is used for prediction as the torque rise point P (#507).

Subsequently, on the basis of the torque rise point P the life of the fixing device 17 is predicted (#508), and the predicted result is notified (#509).

According to the above embodiment, it is possible, in a pad type fixing device 17, to easily predict the time when the lubricant 80 is almost exhausted, that is, the state immediately before occurrence of film breakage.

[Modification]

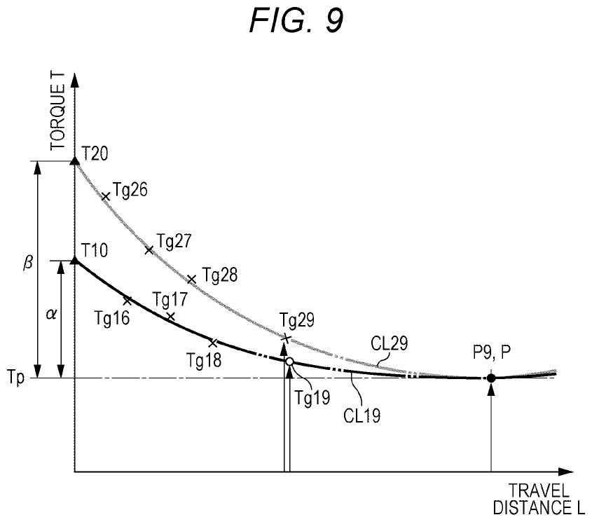

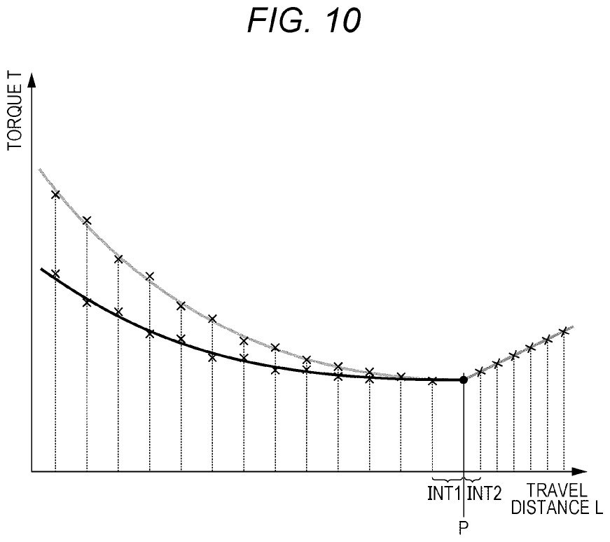

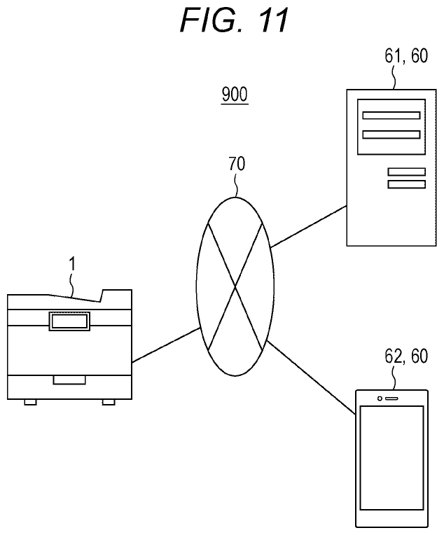

FIG. 9 illustrates a transition curve CL for explaining an example of calculating the acquired torque Tg using the ratio of the torque T at the set temperature H1 and the torque T at the set temperature H2. FIG. 10 illustrates an example in which the interval INT is different between before and after the torque rise point P. FIG. 11 illustrates an example of a control system 900.

In the above-described embodiment, when the torque acquisition unit 173 has acquired one of the acquired torque Tg1 and the acquired torque Tg2, the other may be calculated. In this case, for example, the following processing is performed. Hereinafter, the set temperature of the acquired torque Tg to calculate will be referred to as a “reference temperature”.

The storage unit 174 preliminarily stores the torque T at the set temperature H1 when the travel distance L is a predetermined distance (for example, 0) as “T10”, and preliminarily stores the torque T at the set temperature H2 as “T20”. Note that these values of the torque T may be calculated experimentally.

As illustrated in FIG. 9, the transition prediction unit 175 generates a transition curve CL19 on the basis of the torque values Tg16, Tg17, and Tg18 being the acquired torque Tg1, similarly to the above, and generates a transition curve CL29 on the basis of torque values Tg26, Tg27, Tg28, and Tg29 being the acquired torque Tg2. The point prediction unit 176 predicts a point “P9” where the transition curves CL19 and CL29 intersect each other, as the torque rise point P similarly to the above.

Subsequently, when the set temperature H1 is a reference temperature, the latest acquired torque Tg (Tg2) of the set temperature H2 is “Tg29”, the value obtained by subtracting the torque Tp at P9 from T10 is “α”, and the value obtained by subtracting the torque Tp at P9 from T20 is “β”, then, “Tg19”, which is the acquired torque Tg (Tg1) of the reference temperature (set temperature H1) corresponding to Tg29, can be obtained by the following Formula (1).

Tg19=Tp+(Tg29−Tp)×(α/β) (1)

where “α/β” is a ratio of the torque T at the set temperature H1 to the torque T at the set temperature H2 (hereinafter referred to as a “torque ratio”). The torque ratio is regarded to be constant even when the travel distance L changes. Therefore, in acquisition of the torque ratio, the acquired torque Tg1 and the acquired torque Tg2 corresponding to the acquired torque Tg1 may be used instead of the torque T (T10 or T20) preliminarily stored in the storage unit 174.

The above-described processing of calculating one of the acquired torque Tg1 or the acquired torque Tg2 on the basis of the other of these may be skipped after the latest acquired torque Tg and the latest torque Tp match, that is, after the current torque T has reached the latest torque Tp.

In the above-described embodiment, the torque acquisition unit 173 may continuously acquire the acquired torque Tg even after the latest acquired torque Tg matches the latest torque Tp. In this case, the interval INT may be varied before and after the latest acquired torque Tg and the latest torque Tp match, that is, before and after the torque rise point P.

That is, as illustrated in FIG. 10, for example, the interval INT2 after the torque rise point P is set to be shorter than the interval INT1 before the torque rise point P. This makes it possible to finely check the state of the fixing device 17 and quickly confirm that the fixing device 17 has reached the end of its life.

In the above-described embodiment, the processing by the transition prediction unit 175 and the processing by the point prediction unit 176 described above may be skipped after the latest acquired torque Tg and the latest torque Tp match.

In the above-described embodiment, it is allowable to skip acquisition of the acquired torque Tg by the torque acquisition unit 173 until the current integrated use amount reaches the cumulative use amount of the torque rise point P after the point prediction unit 176 predicts the torque rise point P even once.

In the above-described embodiment, as illustrated in FIG. 11, it is allowable to construct a control system 900 in which the image forming apparatus 1 and the information processing apparatus 60 such as a server 61 and a smartphone 62 for managing the image forming apparatus 1 are connected via a communication line 70 such as the Internet or a public line. Moreover, data indicating the acquired torque Tg or the like may be transmitted from the image forming apparatus 1 to the information processing apparatus 60, and the processing corresponding to the individual processing of the transition prediction unit 175, the point prediction unit 176, and the life prediction unit 177 described above may be performed on the information processing apparatus 60. Subsequently, data indicating the predicted life may be transmitted from the information processing apparatus 60 to the image forming apparatus 1, and the notification processing unit 178 may notify the predicted life.

Alternatively, data indicating the acquired torque Tg and the torque rise point P may be transmitted from the image forming apparatus 1 to the information processing apparatus 60, and the information processing apparatus 60 may analyze the status of change in the image forming apparatus 1 over time, on the basis of the data. Furthermore, the time to visit the user for the maintenance of the image forming apparatus 1 may be determined on the basis of results of the analysis.

In the above-described embodiment, the fixing temperature H includes two temperatures, namely, the set temperatures H1 and H2. However, three or more set temperatures may be used depending on the printing mode. Furthermore, the number of generated transition curves CL may be increased in accordance with the number of set temperatures.

In the above-described embodiment, the number of options (values) for setting the values of the set temperatures H1 and H2 is not limited to one. When there are a plurality of options having similar values as the options of the set temperatures H1 and H2, the plurality of options may be used as the set temperatures H1 and H2. That is, a group of temperatures close to each other having a difference in torque T at each of temperatures as smalls as an error may be set as the set temperatures H1 and H2. In this case, the torque T is measured in a printing mode in which various temperatures belonging to the group are set to the fixing temperature H. Note that it is necessary to select the set temperature H1 and the set temperature H2 so that their difference in torque T is a sufficiently large difference exceeding an error range.

For example, regarding the above-described set temperature H1, not only 165° C. but also any one or more temperatures from 170° C. to 160° C. may be used as the set temperature H1. Furthermore, regarding the above-described set temperature H2, not only 145° C. but also any one or more temperatures from 150° C. to 140° C. may be used as the set temperature H2.

In the above-described embodiment, the torque rise point P is a point where the transition curves CL1 and CL2 intersect each other. Alternatively, however, a point at which the transition curves CL1 and CL2 comes in close proximity even without intersecting each other (for example, a point of torque T that is a few percent shifted from the torque Tp) may be predicted as the torque rise point P.

In the above-described embodiment, the torque T is measured on the basis of the q-axis current value Id. Alternatively, a torque sensor may be provided in the fixing motor 30 and the torque T may be measured on the basis of the detection signal.

In the above-described embodiment, the notification processing unit 178 may notify that the fixing device 17 reaches its life when the current cumulative use amount has reached the cumulative use amount at the torque rise point P, or reached an amount obtained by adding a predetermined value to the cumulative use amount. Alternatively the notification processing unit 178 may notify that the fixing device 17 reaches its life when the current torque T has reached the torque Tp, or reached the torque obtained by adding a predetermined value to the torque Tp after reaching the torque Tp.

In the above-described embodiment, if the difference between the cumulative use amount of the torque rise point P and the current cumulative use amount is equal to or less than a predetermined value, the notification processing unit 178 may display a message recommending that the user should contact a service engineer. Alternatively, it is allowable to let the lubricant reservoir 77 (refer to FIG. 2) to supply the lubricant 80 to the inner surface of the fixing belt 71.

The above embodiment has described the case where the torque rise point is predicted for the pad 74 and the fixing belt 71 in the pad type fixing device 17. The present invention, however, can be applied to a case where prediction is performed for a torque rise point at which the torque of the motor starts to rise due to the decrease in the lubricant interposed to achieve smooth rotation of various fixing members such as the heating roller 72, the pressure roller 75, or other rollers or a rotating body.

In addition, the configuration of the whole or each of parts of the image forming apparatus 1, the content, order, or timing of processing, the heating method of the fixing belt 71, the type of the fixing motor 30, the configuration of the motor drive circuit 21, or the like, can be altered appropriately within the scope and spirit of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus having a pad type fixing device in which a lubricant is interposed between a fixing belt for heating a sheet and a pad for holding the fixing belt, the image forming apparatus comprising:
a controller that controls a heater of the fixing belt so as to maintain a fixing temperature to be set in accordance with printing modes, at a set temperature;
an acquisitor that acquires torque of a motor for rotating the fixing belt as acquired torque for each of a plurality of the set temperatures;
a transition predictor that predicts transition of the torque of the motor for each of the plurality of set temperatures on the basis of the acquired torque; and
a point predictor that predicts a point at which at least two transition curves based on the predicted transition intersect each other as a torque rise point at which the torque of the motor starts rising due to a decrease in the lubricant.

2. The image forming apparatus according to claim 1,
wherein the acquisitor acquires the acquired torque on the basis of a value of a current flowing through winding of the motor.

3. The image forming apparatus according to claim 1,
wherein, after the latest acquired torque matches the latest torque rise point, the acquisitor shortens an interval for acquiring the acquired torque more than before the time when the latest acquired torque matches the latest torque rise point.

4. The image forming apparatus according to claim 1,
wherein the transition predictor newly predicts the transition every time the acquired torque is newly acquired, and
the point predictor newly predicts the torque rise point on the basis of the newly predicted transition.

5. The image forming apparatus according to claim 4,
wherein the transition predictor newly predicts the transition until the latest acquired torque matches the latest torque rise point, and
the point predictor newly predicts the torque rise point until the latest acquired torque matches the latest torque rise point.

6. The image forming apparatus according to claim 1,
wherein the controller controls the heater using a first temperature or a second temperature as the set temperature, and
the acquisitor acquires first torque that is torque of the motor when the set temperature is the first temperature, as first acquired torque, and acquires second torque that is torque of the motor when the set temperature is the second temperature, as second acquired torque.

7. The image forming apparatus according to claim 6,
wherein the acquisitor calculates the latest second torque corresponding to the latest first acquired torque on the basis of a ratio of the first acquired torque other than the latest first acquired torque to the second acquired torque corresponding to the first acquired torque and on the basis of the latest first torque, and acquires the calculated latest second torque, as the second acquired torque.

8. The image forming apparatus according to claim 1,
wherein the acquisitor acquires the acquired torque on the basis of a travel distance of the fixing belt with respect to the pad, a cumulative printing count of the image forming apparatus, or an cumulative operating time of the fixing device.

9. The image forming apparatus according to claim 8, further comprising
a life predictor that predicts life of the fixing device on the basis of the torque rise point, the travel distance, the cumulative printing count, or the cumulative operating time.

10. A torque rise point predicting method comprising:
controlling a heater of a fixing member that heats a sheet so as to maintain a fixing temperature set in accordance with printing modes, at a set temperature;
acquiring torque of a motor for rotating the fixing member as acquired torque for each of a plurality of the set temperatures;
predicting transition of the torque of the motor for each of the plurality of set temperatures on the basis of the acquired torque; and
predicting a point at which at least two transition curves based on the predicted transition intersect each other as a torque rise point at which the torque of the motor starts rising due to a decrease in a lubricant being interposed in order to achieve smooth rotation of the fixing member.

11. A non-transitory recording medium storing a computer readable program for controlling an image forming apparatus having a pad type fixing device in which a lubricant is interposed between a fixing belt for heating a sheet and a pad for holding the fixing belt,
the program causing the image forming apparatus to execute:
controlling a heater of the fixing belt so as to maintain a fixing temperature to be set in accordance with printing modes, at a set temperature;
acquiring torque of a motor for rotating the fixing belt as acquired torque for each of a plurality of the set temperatures;
predicting transition of the torque of the motor for each of the plurality of set temperatures on the basis of the acquired torque; and
predicting a point at which at least two transition curves based on the predicted transition intersect each other as a torque rise point at which the torque of the motor starts rising due to a decrease in the lubricant.

12. A control system comprising:
an image forming apparatus having a pad type fixing device in which a lubricant is interposed between a fixing belt for heating a sheet and a pad for holding the fixing belt; and an information processing apparatus,
wherein the image forming apparatus includes:
a controller that controls a heater of the fixing belt so as to maintain a fixing temperature to be set in accordance with printing modes, at a set temperature;
an acquisitor that acquires torque of a motor for rotating the fixing belt as acquired torque for each of a plurality of the set temperatures;
a transition predictor that predicts transition of the torque of the motor for each of the plurality of set temperatures on the basis of the acquired torque;
a point predictor that predicts a point at which at least two transition curves based on the predicted transition intersect each other as a torque rise point at which the torque of the motor starts rising due to a decrease in the lubricant; and
a transmitter that transmits the torque rise point to the information processing apparatus,
wherein the information processing apparatus includes a determiner that determines a time to perform maintenance on the image forming apparatus on the basis of the torque rise point.
